(19) United States
(12) Patent Application Publication
(10) Pub. No.: US 2026/0346648 A1
(43) Pub. Date: Nov. 5, 2026

(54) TIRE COMPRISING A FLEXIBLE TREAD

(71) Applicant: COMPAGNIE GENERALE DES ETABLISSEMENTS MICHELIN, Clermont-Ferrand (FR)

(72) Inventors: ALAIN DELCOURT, Clermont-Ferrand (FR); GUILLAUME DEMAZIERE, Clermont-Ferrand (FR)

(21) Appl. No.: 19/486,565

(22) PCT Filed: May 16, 2024
(86) PCT No.: PCT/EP2024/063480

§ 371 Date: Nov. 21, 2025

(30) Foreign Application Priority Data
May 24, 2023 (FR) FR2305117

(51) Int. Cl. B60C 9/11; B60C 9/02

(52) U.S. Cl. CPC B60C 9/11; B60C 2009/0269; B60C 2200/12

(57) ABSTRACT

A tire (1) comprises a tread (6) joined, via two sidewalls (7), to two beads (4), a composite layer (9) formed of mutually parallel reinforcers (100) that are coated in an elastomeric compound, forming a carcass reinforcement (2) by being wound, in each bead (4), around a bead wire (8) so as to create a turn-up, the composite layer (9) continuing radially on the outside of the carcass reinforcement (2) so as to form a crown reinforcement (5) comprising two crown layers (51, 52) that are radially superposed on the inside of the tread (6), the reinforcers (100) of the composite layer (9) being connected by weft threads (110) such that the reinforcers and the weft threads (110) form a woven fabric in which the density of weft threads is at least equal to half the density of the reinforcers of the woven fabric.

The present invention relates to a bicycle tyre designed to have a carcass reinforcement and a crown reinforcement that are optimized for performance aspects such as puncture resistance, while having a production cost that is minimized compared with conventional designs.

Furthermore, the invention applies to all types of bicycles, such as road bikes, mountain bikes, hybrid bikes, bicycles with motors, for example electric motors.

The invention also applies to tyres of the tubeless type, that is to say mounted directly on a rim without an air chamber, or to “tube-type” tyres that require the presence of an air chamber.

By convention, consideration is given to a frame of reference (O, OX, OY, OZ), the centre O of which coincides with the centre of the tyre; the circumferential direction OX, axial direction OY and radial direction OZ refer to a direction tangential to the tread surface of the tyre in the direction of rotation, to a direction parallel to the axis of rotation of the tyre, and to a direction orthogonal to the axis of rotation of the tyre, respectively.

Radially inner/radially on the inside and radially outer/radially on the outside mean closer to and further away from the axis of rotation of the tyre, respectively.

Axially inner/axially on the inside and axially outer/axially on the outside mean closer to and further away from the equatorial plane of the tyre, respectively, the equatorial plane of the tyre being the plane that passes through the middle of the tread of the tyre and is perpendicular to the axis of rotation of the tyre.

The makeup of a tyre is usually described by a representation of its constituent components in a meridian plane, i.e. a plane containing the axis of rotation of the tyre. Such a choice is motivated by the axisymmetry of the geometry of the tyre about its axis of rotation. The tyre also comprises a plane of symmetry which is orthogonal to the axis of rotation and passes through the centre of the tread: this is the equatorial plane.

Usually, a tyre comprises a tread intended to be in contact with the ground, and radially on the inside a crown reinforcement. The crown reinforcement and the tread make up the crown of the tyre. A carcass reinforcement radially on the inside of the crown reinforcement gives the tyre the solidity necessary for supporting the intended load.

An elastomeric compound is understood to be an elastomeric material obtained by blending its various constituents. An elastomeric compound conventionally comprises an elastomeric matrix with at least one diene elastomer of the natural or synthetic rubber type, at least one reinforcing filler of the carbon black type and/or of the silica type, a crosslinking system that is usually sulfur-based, and protective agents. For some applications, the elastomers in question may also comprise thermoplastics (TPE).

The expression “composition based on/-based composition” should be understood as meaning a composition including the mixture and/or the reaction product of the various constituents used, some of these base constituents being capable of reacting, or being intended to react, with one another, at least partially, during the various phases of manufacture of the composition, in particular during its crosslinking or vulcanization.

For the purposes of the present invention, the expression “part by weight per hundred parts by weight of elastomer” (or phr) should be understood as meaning the part by mass per hundred parts of elastomer present in the rubber composition in question.

An elastomeric compound can be mechanically characterized, in particular after curing, by its dynamic properties, such as a dynamic shear modulusG*=(G′2+G″2)1/2, where G′ is the elastic shear modulus and G″ is the viscous shear modulus, and a dynamic loss Tan δ=G″/G′. The dynamic shear modulus G* and the dynamic loss Tan δ are measured on a Metravib VA4000 viscosity analyser according to the standard ASTM D 5992-96. The response of a sample of vulcanized elastomeric compound to a simple alternating sinusoidal shear stress, at a frequency of 10 Hz and at a temperature of 100 °C, is recorded. A strain amplitude sweep is carried out from 0.1% to 50% (outward cycle) and then from 50% to 0.1% (return cycle). For the outward cycle, the maximum value of tan (δ) observed, denoted Tan (δ)ₘₐₓ, is indicated.

### PRIOR ART

A bicycle tyre has to react to a wide variety of stress loadings depending on its destination. The users of a bicycle for urban use or of a mountain bike have expectations linked to the specific use thereof, but performance aspects such as puncture resistance, resistance to pinch shocks, or the airtightness of the tyre are expectations shared by all users.

Moreover, the users of bicycle tyres have the shared desire to maximize the efficiency of their tyre, this being the capacity of the tyre to restore the energy provided by the cyclist under running conditions. In other words, it is the ratio between the energy restored under running conditions divided by the energy provided by the cyclist.

This efficiency will depend on several factors, in particular the tread pattern, the rolling resistance and the inflation pressure. The efficiency also depends on the choice of the materials used and on the architecture of the tyre.

The architecture of the tyre is understood to be the stack of profiled elements, of layers of materials and the relative positioning thereof to obtain a tyre which complies with specifications relating to given industrial and technical performance aspects. The architecture is often designed by means of successive iterations with performance simulation phases.

According to a first known design, in the case of a carcass reinforcement comprising one carcass layer, the free ends of each turn-up can extend as far as the crown of the tyre, at which they are positioned radially on the inside of the tread and radially on the outside of the carcass layer; moreover, they are radially superposed with one another so as to form a partial mutual overlap of the two turn-ups. In an overlap-type design, an additional reinforcing layer, connecting the two beads together, can be positioned between the carcass layer and its turn-ups. By way of example, such an additional layer may be made of a nylon fabric. The effect of this additional reinforcement is to improve the resistance of the carcass reinforcement to punctures and cuts, and to pinch shocks.

According to a second known design, each bead comprises a filling element made of elastomeric material, which extends radially on the outside of the bead wire and axially between the carcass layer and its turn-up. Since the axial direction is the direction of the axis of rotation of the tyre, “axially inner/axially on the inside” and “axially outer/axially on the outside” mean “closer to” and “further away from the equatorial plane of the tyre along the axial direction”, respectively, the equatorial plane of the tyre passing through the middle of the tread of the tyre and being perpendicular to the axis of rotation of the tyre. Such a filling element stiffens the bead. On account of its deformation capacity and the decoupling that it brings about between the carcass layer and its turn-up, it also makes it possible to better absorb the deformation energy generated by a pinch shock. Consequently, it is a solution that also improves the resistance to pinch shocks.

According to a third known design, the carcass reinforcement of a bicycle tyre is made up of at least two carcass layers that are wound, in each bead, from the inside to the outside, about a bead wire, so as to form a turn-up. Preferably, the reinforcers of a carcass layer are crossed from one carcass layer to the next and form an angle equal to 45° with the circumferential direction of the tyre. The free ends of the respective turn-ups of each carcass layer are radially superposed, radially on the inside of the tread, at the crown, so as to form an overlap. Moreover, each bead comprises a filling element made of elastomeric material, which extends radially on the outside of the bead wire and axially between the axially outermost carcass layer and the corresponding axially innermost turn-up. The combination of a carcass reinforcement comprising at least two carcass layers and of a filling element in each bead advantageously makes it possible to resist pinch shocks.

The document EP3797040B1 discloses a bicycle tyre comprising an anti-puncture system consisting of a tread having a protective layer capable of providing resistance to the penetration of foreign bodies.

However, there is a need to simplify the design of bicycle tyres, maintaining the same performance aspects while lowering industrial production costs.

The inventors set themselves the objective of simplifying the architecture of bicycle tyres while improving endurance, more specifically puncture resistance, without having a negative effect on the industrial production costs.

This aim has been achieved by the design of a bicycle tyre comprising a tread intended to be in contact with underlying ground, said tread being joined, via two sidewalls, to two beads that are intended to be in contact with a rim, a composite layer formed of mutually parallel reinforcers that form an angle ranging from 40° to 60°, preferably between 40° and 60°, with a circumferential direction and are coated in an elastomeric compound, forming a carcass reinforcement by being wound, in each bead, around a bead wire so as to create a turn-up, said composite layer continuing radially on the outside of the carcass reinforcement so as to form a crown reinforcement comprising two crown layers that are radially superposed on the inside of the tread and resulting from the overlapping of the ends of said composite layer, said tyre being characterized in that the parallel reinforcers of the composite layer are connected by weft threads such that the parallel reinforcers and the weft threads form a woven fabric in which the density of weft threads is at least equal to half the density of the reinforcers of the woven fabric, the density of threads or of reinforcers being the number of threads or of reinforcers per decimetre.

Any range of values denoted by the expression “between a and b” represents the range of values ranging from more than a to less than b (i.e. excluding the limits a and b), whereas any range of values denoted by the expression “from a to b” means the range of values ranging from a to b (i.e. including the strict limits a and b).

The architecture of the tyre according to the invention has been simplified to the extent that a single composite layer forming a woven fabric makes up both the carcass reinforcement and the crown reinforcement. The overlapping of the two, radially superposed ends of the composite layer made of woven fabric forms the crown reinforcement.

The density of the reinforcers in the composite layer is determined by counting the number of parallel reinforcers per decimetre in the direction normal to the direction defined by the parallel reinforcers. In the same way, the density of the weft threads in the composite layer is determined by counting the number of weft threads per decimetre in the direction normal to the direction of the weft threads. The direction of the weft threads is oblique with respect to that of the reinforcers, and preferably orthogonal to the direction of the reinforcers.

The combination of the overlap architecture of a bicycle tyre and of the use of a woven fabric with a high density of weft threads is at the heart of the invention. A high density of weft threads is understood to be a number of threads per decimetre that is significantly higher than in common practice, being at least equal to half the number of reinforcers per decimetre. In this way, the advantages of these two technologies are combined both to benefit from a simplification of the architecture of the tyre and to save on industrial production costs.

Innovative and unexpected technical effects give the tyres according to the invention advantageous properties. The overlap architecture results in a crown reinforcement with at least three passages of the composite layer under the crown, and two passages at the sidewalls. The woven fabric of the composite layer has weft threads that have a count greater than 10 tex, but above all, said woven fabric may comprise a density of weft threads greater than half the density of the reinforcers.

With a high density of weft threads, the composite layer that forms both the carcass reinforcement and the crown reinforcement constitutes, as it were, an effective mesh for protecting the crown from perforations. This protective mesh is located on the transverse walls of the tyre via the sidewalls, where the composite layer passes twice on account of the overlap architecture.

An example of a reinforcer that is used is a nylon cord formed of a strand with a count of 47 tex. This cord is used to form a fabric with 160 reinforcers per decimetre. The density of weft threads in this example is also 160 threads per decimetre.

There are two main methods for obtaining the composite fabrics used in the tyre design. There are fabrics produced by the direct calendering of an array of parallel and equidistant reinforcers, which consists in applying a layer of elastomeric compound on either side of the array of parallel reinforcers in order to obtain a composite layer. This is referred to as the “straight grain” method.

There is another approach, which consists in connecting the reinforcers by a weft thread, often orthogonally to the direction of said reinforcers, such that the parallel reinforcers and the weft threads form a woven fabric. This is followed by a step of calendering on either side of the woven fabric so as to result in a composite layer.

The use of woven fabrics in the design of passenger-vehicle, aircraft and agricultural tyres is known per se. The weft threads were initially introduced to improve the productivity of the manufacture of fabrics compared with straight grain methods. To obtain a fabric, the textile needs to undergo a treatment comprising a phase of adhesive application and of drying, followed by a thermomechanical treatment prior to the final calendering step. The use of the textile in the form of a woven fabric makes these various manufacturing steps easier.

However, in the case of bicycle tyres according to the invention, the woven fabric is characterized by a high density of weft threads and contributes to the mechanical behaviour of the carcass and crown reinforcements. This additional provision of stiffnesses in the plane of the woven composite layer makes it possible to simplify the architecture of the tyre by doing away with certain layers of materials that are used in the conventional design based on straight grain fabrics. The result is a significant drop in the mass of the tyre, which manifests itself as a drop in the material costs that is directly apparent in the industrial production costs of the tyre.

A mass saving of 16% in the mass of a tyre according to the invention is observed.

The combination of the main features of the invention, namely the choice of the overlap architecture combined with the use of a high-density woven fabric, results in the tyre according to the invention, which solves the technical problem set out above.

Further features of the invention associated with the nature of the woven fabric both in terms of the reinforcers and in terms of the weft thread, combined with the overlap architecture make it possible to optimize even further the compromise between the technical and industrial performance aspects of the tyres according to the invention.

Advantageously, the weft thread has a count ranging from 10 tex to 60 tex, preferably between 10 tex and 60 tex. The use of a cotton weft thread is the conventional solution encountered commercially for woven fabrics. For technical and economic reasons, it is advantageous for the weft thread to be made from a material of the same type as the reinforcers, meaning that the textile used to make the weft thread and the reinforcer is the same. In the abovementioned example, with a nylon reinforcer of 47 tex, the weft thread is also made of nylon, but optionally with a different count.

Another surprising result is the improvement in the airtightness of the tyre for preserving the internal inflation air, such that the airtight inner-liner, conventionally made of a butyl material, can be removed from the architecture of a tyre according to the invention. Specifically, the inventors have found that the layer of elastomeric coating compound of the composite layer provides effective airtightness with regard to the internal inflation air. Therefore, advantageously, the coating compound of the reinforcers of the composite layer constitutes the airtight inner-liner in the cavity of the tyre.

By virtue of the overlap architecture, advantageously, the crossed working crown layers are formed by the overlapping of the axial ends of the composite layer forming the crown reinforcement. This superposition of woven composite layers under the crown, namely the passage of the carcass layer and the overlapping of the axial ends of the composite layer, reinforces the crown of the tyre with respect to perforations. In the conventional designs without woven fabrics, a protective layer is added to the crown, but in the context of this invention, this addition is no longer necessary as a general rule. However, for very particular uses in which the tyres are particularly stressed, for example on off-road paths, it is advantageous for the crown reinforcement to comprise at least one protective composite layer, arranged radially on the outside of the crown reinforcement and radially on the inside of the tread.

Advantageously, the protective composite layer is made from the same material as the composite layer forming the crown reinforcement. This means that all the constituent elements of the composite layer are identical to those in the protective composite layer (type of reinforcers, type of weft threads, counts, twist, densities, type of coating compound, thickness of the layers, etc.). In this embodiment, the benefit is that of standardizing the materials used in order to save on material costs.

Another contribution of the overlap architecture can be seen through the sidewalls. Advantageously, each sidewall comprises at least two woven composite layers. As a result, the lateral protection of the tyres according to the invention is enhanced.

Advantageously, the bead wire is made of a metal material. Two categories of tyre are distinguished, the appearance of which depends on the type of bead wires. A first category of tyres is produced with metal bead wires, consisting of a winding of a metal wire, the number of turns depending on the size and the use of the tyre and in particular on its use pressure. These tyres are then in their final form, i.e. a tyre forming a torus and therefore having non-negligible space requirement for transport or storage.

For a second category of tyre, the bead wire is made of a textile material. To simplify the storage and transport of bicycle tyres, a second category of tyres has been proposed, which can be folded in order to limit the space requirement thereof. Such tyres are produced with bead wires made of textile material that can be deformed elastically without having a detrimental effect on their performance aspects when they return to their initial shape. Preferably, the bead wire is made of an aromatic polyamide material.

Advantageously, the woven composite layer forming the carcass reinforcement and the crown reinforcement has a circumferential length ranging from 1200 mm to 2000 mm, preferably between 1200 mm and 2000 mm, and an axial width ranging from 120 mm to 450 mm, preferably between 120 mm and 450 mm.

The circumferential length of the composite layer is understood to be its extent in the circumferential direction before it is laid on the tyre building drum. In the same way, the axial width corresponds to its axial extent.

The inventors pushed the standardization of the materials used to manufacture a tyre as far as possible. With only one surface of woven composite fabrics ranging from 0.144 m² to 0.9 m², preferably between 0.144 m² and 0.9 m², it is possible to assembly a tyre according to the invention. When the tyre has a protective layer, this same woven composite fabric can be used.

Preferably, the reinforcers of the composite layer are textile cords, each textile cord being obtained by twisting a twist T2 of N strands of a textile material in a given direction D1 (the S or Z direction, respectively), with N>1, each strand resulting from overtwisting a twist T1 of a spun yarn of said textile material in an opposite direction D2 (Z or S, respectively).

The first material used in the manufacture of a textile cord is the spun yarn stored by being wound on reels of 4 to 12 kg. It is a flat roving made up of continuous elementary filaments that are identical both in terms of appearance and in terms of mechanical properties, said roving coming directly from spinning installations. A spun yarn is defined generally by the type of material of which the filaments are made (PET, nylon, rayon, aramid); its linear density, which is expressed in tex and which represents the mass in grams of 1000 m of spun yarn; the number of elementary filaments that make up the spun yarn (200 to 1500), and the degree of intertwining of the elementary filaments.

Produced from the spun yarns are textile cords, having a double twist (T1, T2), which are prepared by a so-called twisting method in which:
during a first step, the overtwisting, each constituent spun yarn or multifilament fibre (or just “yarn”) of the final cord is first of all twisted individually on itself (with an initial twist T1) in a given direction D1 (the S or Z direction, respectively) in order to form a strand in which the elementary filaments find themselves deformed into a helix around the axis of the fibre (or axis of the strand);
and then, in a second step, the twisting, several strands, generally two, three or four in number, of identical types or different types in the case of so-called hybrid or composite cords, are subsequently twisted together with a final twist T2 (which may be the same as or different from T1) in an opposite direction D2 (the Z or S direction, respectively, according to recognized terminology designating the orientation of the turns according to the central portion of an S or a Z), to produce the cord or final assembly having several strands.

The purpose of the twisting is to adapt the properties of the material so as to create the transverse cohesion of the reinforcer, to improve endurance with respect to compressive stresses and to distribute the stresses over all the filaments. This step of the twisting method is accompanied by a drop in the force at break and the longitudinal modulus and by an increase in resistance to fatigue as the twist increases. Ultimately, the method is parametrized so as to achieve a compromise between fatigue strength and force at break.

The method for obtaining the cord continues with an adhesive application phase so as to ensure the bond between the cord and the elastomeric compound that surrounds it. The quality of the textile/compound interface influences the performance in terms of fatigue of the adhesive-coated cord.

Advantageously, the number N of strands of a textile cord ranges from 1 to 6, preferably between 1 and 6, and more preferentially N=1. An example of such a cord is N 47/1, which means that the cord is made up of the assembly of a nylon strand with a count of 47 tex.

When N=2, an industrial direct cabling process makes it possible, in a single manufacturing step, to produce the overtwisting and the twisting, bringing about a significant increase in productivity. On the other hand, when N=3, the overtwisting and the twisting are carried out in two separate operations in order to create 3-strand constructions.

Advantageously, the spun yarns are made of a hybrid assembly of filaments of textile materials such as an aliphatic polyamide, a polyester, a rayon, an aromatic polyamide.

Advantageously, the count of the cords made of aliphatic polyamide (nylon) that make up the woven composite layer is greater than or equal to 10 tex, preferably greater than or equal to 14 tex, and even more preferably greater than or equal to 47 tex, the count being the linear density of the cord, that is to say the mass expressed in grams per millimetres of cord.

Further details and advantageous features of the invention will become apparent in the following text from the description of exemplary embodiments of the invention given with reference to the figures, which show meridian views of diagrams of a tyre according to embodiments. In order to make them easier to understand, the figures are not shown to scale.

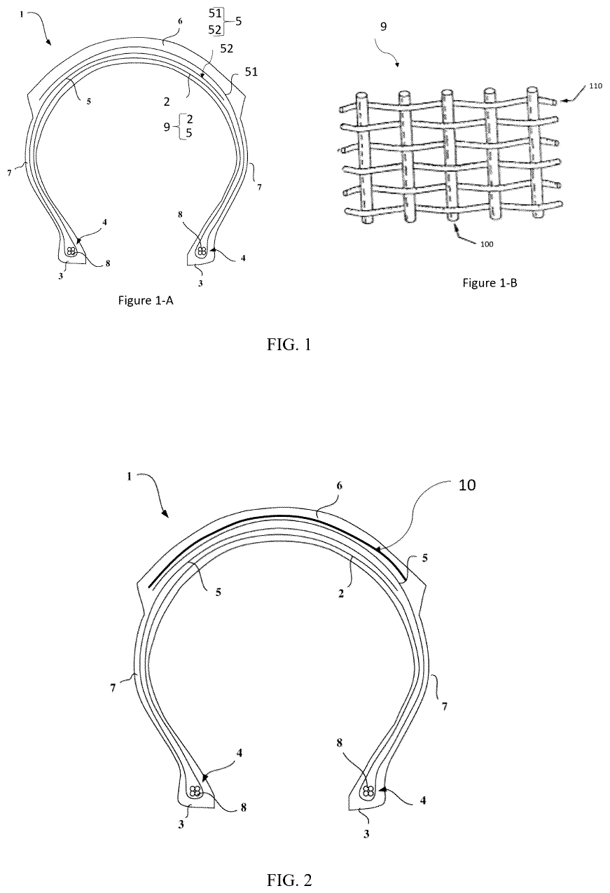

FIG. 1 comprises a view 1-A, which shows a cross section through a tyre according to the invention in a meridian plane, and a view 1-B, which shows an enlarged view of a woven fabric.

FIG. 2 shows an embodiment of the invention with the presence of a protective layer in the crown reinforcement.

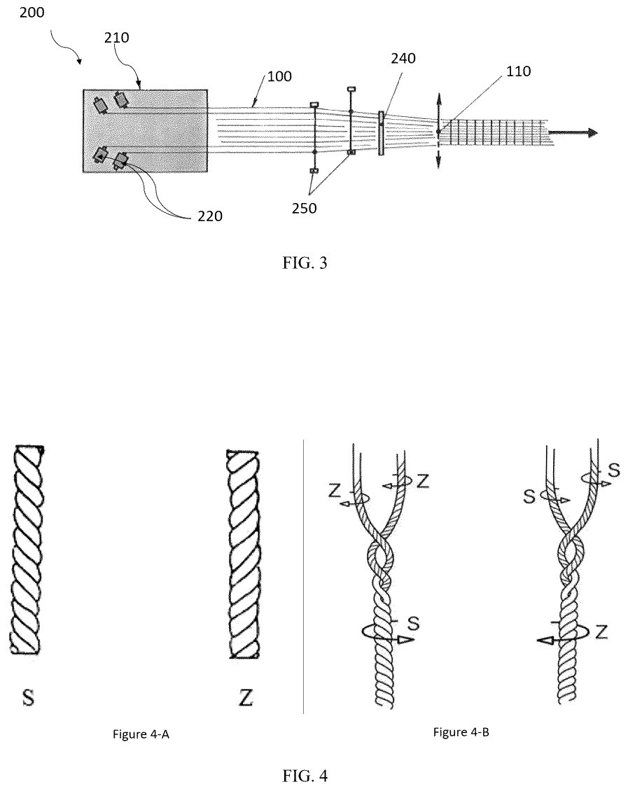

FIG. 3 is a schematic diagram of the weaving process for obtaining the woven fabric with a high density of weft threads according to the invention.

FIG. 4 comprises two views 4-A and 4-B, which show the principle of production of the reinforcers of the woven composite fabric according to the invention. FIG. 4-A illustrates the overtwisting of two aramid spun yarns to form two strands, illustrating the two possible overtwisting directions “S” or “Z”. FIG. 4-B shows the twisting of the two preceding strands to form a cord, used in a composite fabric according to the invention.

The invention was implemented on a tyre of size 25-622 in accordance with the specifications of the ETRTO (European Tyre and Rim Technical Organisation) standard.

In FIG. 1-A, the tyre of general reference 1 comprises a composite layer 9 which forms a carcass reinforcement 2 and a crown reinforcement 5 with two crown layers (51, 52). The carcass reinforcement 2 is made up of a first carcass layer, which is wound around a bead wire 8 in each bead 4 so as to form a loop, then continues in the crown reinforcement 5 to form crown layers (51, 52) made from the axial ends of the composite layer 9. The beads 4 are connected to the tread 6 via two sidewalls 7.

FIG. 1-B shows a piece of woven fabric having textile reinforcing threads 100 connected orthogonally by weft threads 110.

FIG. 2 is an embodiment of the invention in which a protective layer 10 reinforces the crown reinforcement 5, positioned radially on the outside of the crown layers.

FIG. 3 shows the principle of the weaving process of general reference 200 for obtaining the woven fabric 9. The cord reels 220 are installed in the creel 210 which, after the cords have been unwound, makes it possible to obtain a network of parallel cords 100. A cord separation system 250 precedes the passage through the comb 240 for the insertion of the weft threads 110. The particular feature here is that of having a high density of weft threads, which is higher than half the density of the cords of the fabric, and also that the weft threads and the cords are of the same type.

FIG. 4 shows the views 4-A and 4-B. The view 4-A shows two strands obtained by overtwisting in an S-shape and, respectively, overtwisting in a Z-shape of the spun yarns made up of bundles of textile filaments.

FIG. 4-C illustrates the principle of manufacturing the textile cord, with, for example, the overtwisting of two spun yarns in a Z-shape, these then being twisted in the opposite direction in an S-shape in order to obtain a cord.

The dimensional data of the tyre, produced in accordance with the invention, have a sidewall height of 35 mm, and a nominal section width of 25 mm. The angles of the reinforcers of the crown layers with the circumferential direction vary from 40° to 60°. The bead wire is made of textile with an assembly of 18 aramid threads.

The tyre is used with an inflation pressure of 800 kPa.

The composite layer constituting the carcass and crown reinforcements is formed of reinforcers made of nylon 6.6 with a count of 47 tex. These nylon reinforcers are cords formed of one strand. Their force at break is equal to 2.3 daN at 23% elongation, and the density of cords in a composite layer is 40 threads per inch. The diameter of the cords is 39 hundredths of a millimetre, and the composite layer has a thickness of 0.41 mm. The weft threads connecting the cords are also made of nylon with a count of 47 tex. The density of the weft threads in the woven composite layer is 40 threads per inch.

For the tyre size studied, the circumferential length of the composite layer forming the carcass and crown reinforcements is 1944 mm, and its axial width is 168 mm. These dimensions of the composite layer are enough for forming the carcass and crown reinforcements. These values ensure optimal operation of the composite layer both as a carcass reinforcement and as a crown reinforcement.

The elastomeric coating compound of the composite layer is a composition as described below in the following table.

TABLE 1

| | Elastomer | | | |
|---|---|---|---|---|
| | NR | Non- | | |
| | (Natural | reinforcing | Protective | Vulcanizing |
| Compositions | Rubber) | filler | agent | agent |
| Coating | 100 phr | Kaolin | Wax/SPC | S |
| compound of | | (25 phr) | (5.5 phr) | (2.75 phr) |
| the | | | | CBS |
| composite | | | | (1.05 phr) |
| layer | | | | |

The coating compound of the composite layer forming the carcass and crown reinforcement is characterized by the following mechanical properties:

TABLE 2

| Coating compound of the | |
|---|---|
| composite layer | Properties |
| G* (MPa) | 0.74 |
| G′ (MPa) | 0.73 |
| tan (δ) | 0.04 |

The thickness of the coating layer for the cords of the composite layer is less than or equal to 0.1 mm.

Configurations of tyres according to the invention were tested in order to clearly highlight the performance aspects afforded by the invention. The results of these tests were compared with those obtained on a control tyre of the same size, namely: 25-622.

The control T is in accordance with the diagram in FIG. 1-A and corresponds to a tyre of conventional design with an overlap architecture but without a woven fabric. This tyre differs from the invention in that the composite layer forming the carcass reinforcement and the crown reinforcement is not a woven fabric but a so-called straight grain fabric.

First of all, an endurance test was carried out on each of the tyres. This test consists in measuring the degradation resistance of a tyre in contact with a rotating rolling road, provided with harshening bars and subjected to cycles of loading stresses, pressure and speed.

The “breaking energy” test, also known as the polar test, consists in pressing a polar into the sidewall of a tyre inflated to nominal pressure and fitted on a measuring rim. The force applied is measured when the sidewall breaks.

Rolling resistance tests were carried out according to the principles of the standard ISO 28580. For a tested tyre, the result is the coefficient of rolling resistance, which represents the ratio of the resistance force opposing the forward travel of the vehicle owing to hysteresis of the tyres divided by the load supported.

An airtightness test comparing the control and the tyre of the invention was carried out. The test consists in mounting a tyre on a rim, inflating it to a setpoint pressure and monitoring the change in internal pressure over time.

A result greater than (or, respectively, less than) 100% indicates an improvement (or, respectively, a diminution) in the performance criterion under consideration.

The results obtained are set out in the following table:

TABLE 3

| | | | | | Breaking |
|---|---|---|---|---|---|
| | | | Rolling | | Energy |
| | Endurance | Mass | resistance | Airtightness | sidewall |
| Control | 100 | 100 | 100 | 100 | 100 |
| Tyre of the | 100 | 116 | 105 | 200 | 120 |
| invention | | | | | |

The tyres of the invention have an identical endurance performance level, but differ from the prior art through the advantageous compromise between performance aspects other than endurance such as rolling resistance and especially airtightness with respect to the escape of the internal inflation air, the mass and through a very significant saving in industrial production costs.

The invention may also apply, for example, to motor-driven two-wheeled vehicles, to wheelchairs or to strollers.

1.-15. (canceled)

16. A bicycle tire comprising:
a tread intended to be in contact with underlying ground, the tread being joined, via two sidewalls, to two beads that are intended to be in contact with a rim;
a composite layer formed of mutually parallel reinforcers that form an angle ranging from 40° to 60° with a circumferential direction and are coated in an elastomeric compound, forming a carcass reinforcement by being wound, in each bead, around a bead wire so as to create a turn-up, the composite layer continuing radially on an outside of the carcass reinforcement so as to form a crown reinforcement comprising two crown layers that are radially superposed on an inside of the tread and resulting from the overlapping of ends of the composite layer,
wherein the parallel reinforcers of the composite layer are connected by weft threads such that the parallel reinforcers and the weft threads form a woven fabric in which a density of weft threads is at least equal to half a density of the parallel reinforcers of the woven fabric, the density of weft threads or of parallel reinforcers being a number of weft threads or of parallel reinforcers per decimeter.

17. The bicycle tire according to claim 16, wherein the weft threads have a count ranging from 10 tex to 60 tex.

18. The bicycle tire according to claim 16, wherein the elastomeric compound makes up an airtight inner-liner in a cavity of the tire.

19. The bicycle tire according to claim 16, wherein the crown reinforcement comprises at least one protective composite layer arranged radially on an outside of the crown reinforcement and radially on the inside of the tread.

20. The bicycle tire according to claim 19, wherein the at least one protective composite layer is made from a same material as the composite layer forming the crown reinforcement.

21. The bicycle tire according to claim 16, wherein each sidewall comprises at least two woven composite layers.

22. The bicycle tire according to claim 16, wherein the bead wire is made from a metal material.

23. The bicycle tire according to claim 16, wherein the bead wire is made from a textile material.

24. The bicycle tire according to claim 23, wherein the bead wire is made from an aromatic polyamide material.

25. The bicycle tire according to claim 16, wherein the composite layer forming the carcass reinforcement and the crown reinforcement has a circumferential length ranging from 1200 mm to 2000 mm.

26. The bicycle tire according to claim 16, wherein the composite layer forming the carcass reinforcement and the crown reinforcement has an axial width ranging from 120 mm to 450 mm.

27. The bicycle tire according to claim 16, wherein the parallel reinforcers of the composite layer are textile cords, each textile cord being obtained by twisting a twist T2 of N strands of a textile material in a given direction D1, with N>1, each strand resulting from overtwisting a twist T1 of a spun yarn of the textile material in an opposite direction D2.

28. The bicycle tire according to claim 27, wherein the number N of strands in each textile cord ranges from 1 to 6.

29. The bicycle tire according to claim 27, wherein the spun yarn is made of a hybrid assembly of filaments of textile materials.

30. The bicycle tire according to claim 27, wherein a count of the textile cords is greater than or equal to 10 tex, the count being a linear density of the cord or mass expressed in grams per millimeter of cord.
